(19) United States
(12) Patent Application Publication
(10) Pub. No.: US 2025/0242873 A1
(43) Pub. Date: Jul. 31, 2025

(54) TRAILER SPOTTER AND TRANSPORT ASSEMBLY

(71) Applicant: Great Lakes Manufacturing, Inc., Suring, WI (US)

(72) Inventor: Craig P. French, Suring, WI (US)

(73) Assignee: Great Lakes Manufacturing, Inc., Suring, WI (US)

(21) Appl. No.: 19/035,237

(22) Filed: Jan. 23, 2025

Related U.S. Application Data
(60) Provisional application No. 63/624,851, filed on Jan. 25, 2024.

(51) Int. Cl. B62D 53/08; B60D 1/06; B60T 1/08

(52) U.S. Cl. CPC B62D 53/0864; B60D 1/06; B60T 1/08

(57) ABSTRACT

A trailer spotter and transport assembly comprises a first end comprising an axle, the axle comprising at least two wheels; a second end comprising a mover attachment mechanism for attaching to a mover; and a trailer attachment mechanism located between the first and second ends for attaching to a trailer. The trailer spotter and transport assembly further comprises two air tanks for releasing the air brakes on a trailer.

### FIELD

The present disclosure relates to equipment for moving large trailers such as semi-trailers and in particular equipment for enabling movers such as forklifts or the like to move large trailers.

### BACKGROUND

Locations such as dealerships, service centers, terminals, repair shops, or trailer manufacturing facilities have a need to move large trailers such as semi-trailers, fifth wheel campers, gooseneck trailers, and the like. At many of these facilities it is hard to justify the cost and maintenance of a special motorized piece of equipment, and it is often difficult or impractical to use the semi tractor for such tasks. A need exists to adapt equipment already in use, including movers such as forklifts, pallet jacks, tow tractors, hydraulic carts, and the like to perform this task.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a trailer spotter and transport assembly for transporting trailers is provided, comprising a first end comprising an axle, the axle comprising at least two wheels; a second end comprising a mover attachment mechanism for attaching to a mover; and a trailer attachment mechanism located between the first and second ends for attaching to a trailer.

In one embodiment, the trailer attachment mechanism is a fifth wheel coupler.

In one embodiment, the trailer attachment mechanism is a gooseneck coupler.

In one embodiment, the trailer attachment mechanism is adapted to comprise both a fifth wheel coupler and a gooseneck ball coupler.

In one embodiment, the mover is a forklift.

In one embodiment, the mover is one of a group including a towing machine, a skid steer, a telehandler, or a compact trailer.

In one embodiment, the trailer spotter and transport assembly further comprises an angled drop style frame.

In one embodiment, when the trailer attachment mechanism is attached to a trailer and the movement attachment mechanism is attached to a mover the assembly enables the mover to reposition the trailer.

In one embodiment, the axle supports 50% of the weight of the trailer and the mover supports 50% of the weight of the trailer.

In one embodiment, the trailer spotter and transport assembly further comprises at least one air tank reservoir comprised to release a parking brake on a trailer.

In one embodiment, the trailer spotter and transport assembly further comprises an air supply connected to the at least one air tank reservoir.

In one embodiment, the trailer spotter and transport assembly further comprises a portable compressor adapted to refill the at least one air tank reservoir.

These and still other advantages of the invention will be apparent from the detailed description and drawings. Various other features, objects, and advantages will be made apparent from the following description taken together with the drawings. What follows is merely a description of some preferred embodiments of the present invention. To assess the full scope of the invention, the claims should be looked to as these preferred embodiments are not intended to be the only embodiments within the scope of the claims.

### BRIEF DESCRIPTION OF THE DRAWINGS

FIG. 1 shows a top view of a trailer spotter and transport assembly.

FIG. 2 shows a top view of a trailer spotter and transport assembly.

FIG. 3 shows a side view of a trailer spotter and transport assembly.

FIG. 4 shows a side view of a trailer spotter and transport assembly.

FIG. 5 shows a side view of a trailer spotter and transport assembly.

FIG. 6 shows a front view of a universal quick attach/fork mount.

FIG. 7 shows a side view of a universal quick attach/fork mount.

FIG. 8 shows a top view of a universal quick attach/fork mount.

### DETAILED DESCRIPTION

Citations to a number of references may be made herein. Any such cited references are incorporated by reference herein in their entireties. In the event that there is an inconsistency between a definition of a term in the specification as compared to a definition of the term in a cited reference, the term should be interpreted based on the definition in the specification.

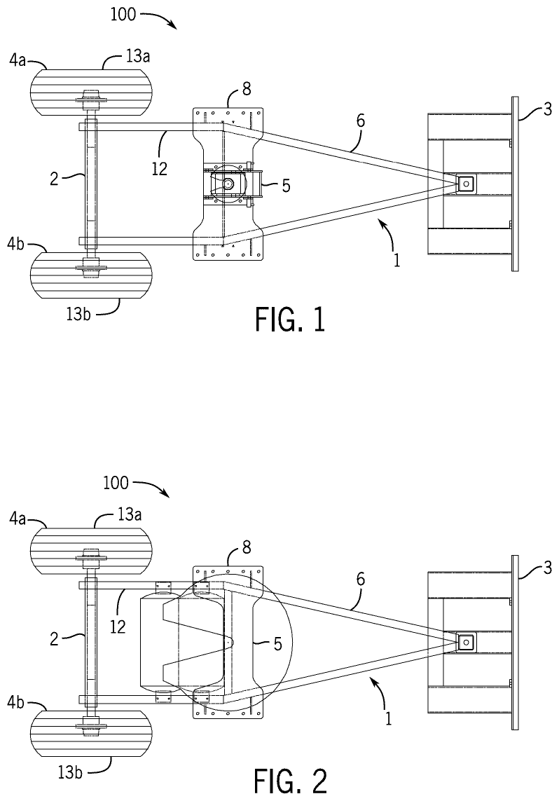

Referring to FIGS. 1-2, an exemplary embodiment of a trailer spotter and transport assembly 100 for transport of a trailer is provided. The assembly 100 comprises a drop style frame 1, comprising a front end 6, a rear end 12, and a center 8. The front end 6 is adapted to attach to mover attachment mechanism 3. The mover attachment mechanism 3 is adapted to attach the trailer spotter and transport assembly 100 to a mover such as a forklift, pallet jack, tow tractor, hydraulic cart, skid steer, telehandler, compact trailer, towing machine, and the like. The drop style frame 1 further comprises a rear end 7. The rear end 7 is adapted to couple with the axle 2. Axle 2 may comprise two wheels 4a and 4b. Wheels 4a and 4b comprise tires 13a and 13b. Tires 13a and 13b may be 12.5 L-15 AG tires. In certain embodiments two or more wheels 4 with corresponding tires 13 may be used. The center 8 comprises trailer attachment mechanism 5. Trailer attachment mechanism 5 may be a standard gooseneck coupler, a standard fifth wheel coupler, or any coupler or combination of couplers which enable the drop style frame 1 to couple to a trailer, a semi-trailer, fifth wheel camper, gooseneck trailer, or the like. When connected to a forklift or other towing machine (not shown) via mover attachment mechanism 3 and coupled with a trailer (not shown) via trailer attachment mechanism 5, drop style frame 1 transfers a substantial portion of the weight of the trailer to the axle 2, with the mover bearing the remaining weight of the trailer. In some embodiments the axle 2 bears approximately 50% of the trailer's weight and the mover bears approximately 50% of the trailer's weight. In this way, the inventors have recognized that movers can reposition heavy trailers and similar items without bearing the entirety or vast majority of the weight of the trailer, making repositioning easier and saving wear and tear on towing machines. In other embodiments, the weight may be distributed in any range from 70% to 30% such that the axle 2 bears approximately between 30% to 70% of the trailer's weight and the mover bears approximately 70% to 30% of the trailer's weight. In still other embodiments, the weight may be distributed in any range from 90% to 10% such that the axle 2 bears approximately between 10% to 90% of the trailer's weight and the mover bears approximately 90% to 10% of the trailer's weight. One of ordinary skill in the art will understand that the axle may bear any percentage of weight between 10% and 90%, and that the mover may bear anywhere any percentage of weight between 90% and 10%.

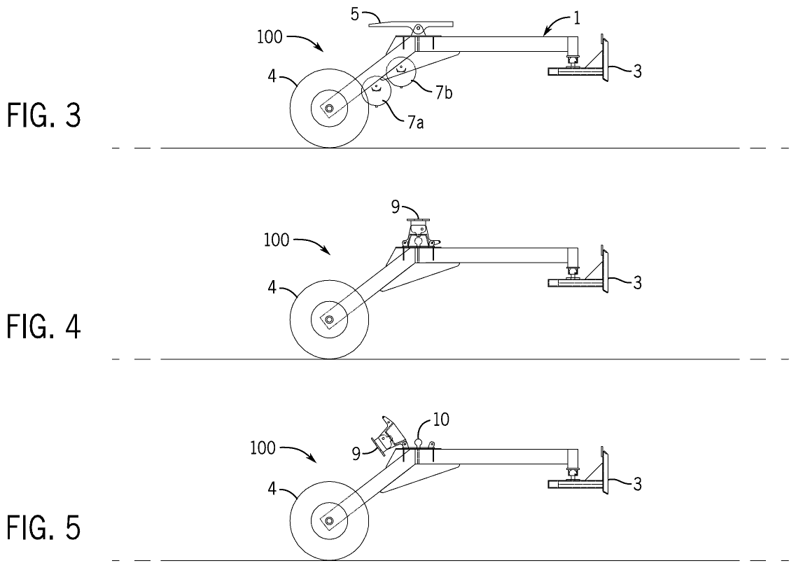

Referring to FIGS. 3-5, a side view of a trailer transport assembly 100 is shown. Trailer transport assembly 100 comprises a mover attachment mechanism 3. Mover attachment mechanism 3 may be a universal quick attach or fork mount attachment mechanism. Mover attachment mechanism 3 is configured to couple trailer transport assembly 100 to a mover such as a forklift, pallet jack, tow tractor, hydraulic cart, skid steer, telehandler, compact trailer, towing machine, and the like. Trailer transport assembly 100 further comprises trailer attachment mechanism 5. Trailer attachment mechanism 5 is configured to couple trailer transport assembly 100 to a trailer, a semi-trailer, fifth wheel camper, gooseneck trailer, or the like. As shown in FIG. 3, trailer attachment mechanism 5 may be a standard fifth wheel assembly. As shown in FIG. 4, trailer attachment mechanism 5 may be a camper 5^{th} wheel hook 9. Camper 5^{th} wheel hook 9 may, as shown in FIG. 5, flip 180 degrees around the axis (not shown) perpendicular to the horizontal trailer transport assembly 100. When camper 5^{th} wheel hook 9 is flipped 180 degrees, gooseneck ball 10 is exposed. Trailer attachment mechanism 5 may be gooseneck ball 10.

Referring to FIG. 3, in some embodiments, air tank reservoirs 7 are provided on the trailer spotter and transport assembly 100. The air tank reservoirs 7 are adapted to connect to a trailer to release the trailer's air brakes (not shown). The air tank reservoirs 7 may be connected to a source of air supply such as the air supply of the shop where they are used (not shown) for the purposes of refilling the air tank reservoirs 7. Alternatively, the air tank reservoirs 7 may further comprise portable air compressors (not shown) to enable continual refilling of the air tank reservoirs 7 without connection to an air supply.

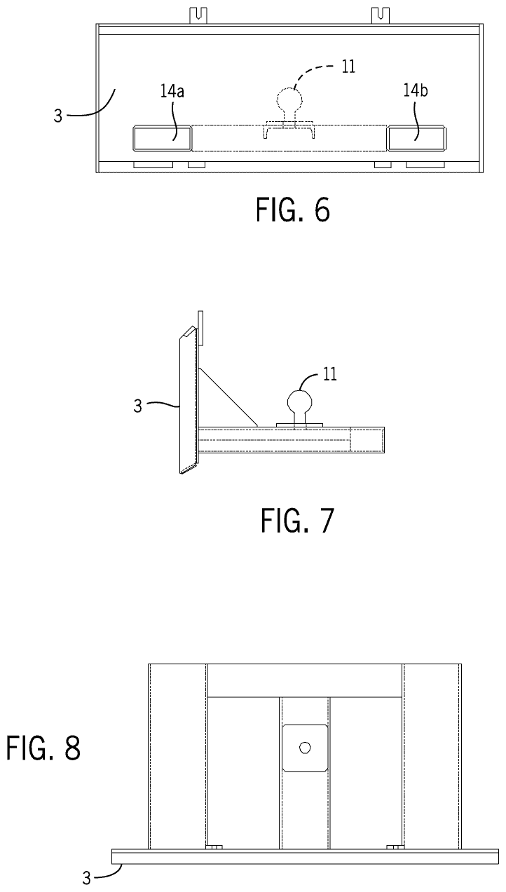

Referring to FIGS. 6-8, a detailed view of a mover attachment mechanism 3 is shown. Mover attachment mechanism 3 comprises coupler 11. Coupler 11 is configured to couple trailer transport assembly 100 to a mover such as a pallet jack, tow tractor, hydraulic cart, skid steer, telehandler, compact trailer, towing machine, and the like. Mover attachment mechanism 3 may also couple trailer transport assembly 100 to a forklift via forklift mounts 14a and 14b (see FIG. 6).

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A trailer spotter and transport assembly for transporting trailers comprising:
a first end comprising an axle, the axle comprising at least two wheels;
a second end comprising a mover attachment mechanism for attaching to a mover; and
a trailer attachment mechanism located between the first and second ends for attaching to a trailer.

2. The system of claim 1, where the trailer attachment mechanism is a fifth wheel coupler.

3. The system of claim 1, where the trailer attachment mechanism is a gooseneck ball coupler.

4. The system of claim 1, where the trailer attachment mechanism is adapted to comprise both a fifth wheel coupler and a gooseneck ball coupler.

5. The system of claim 1, wherein the mover is a forklift.

6. The system of claim 1 wherein the mover is one of a group including a towing machine, a skid steer, a telehandler, or a compact trailer.

7. The assembly of claim 1, wherein the first end and the second end comprise an angled drop style frame.

8. The assembly of claim 1, wherein when the trailer attachment mechanism is attached to a trailer and the movement attachment mechanism is attached to a mover the assembly enables the mover to reposition the trailer.

9. The assembly of claim 8, wherein the axle supports 50% of the weight of the trailer and the mover supports 50% of the weight of the trailer.

10. The assembly of claim 1, further comprising at least one air tank reservoir comprised to release a parking brake on a trailer.

11. The assembly of claim 9, further comprising an air supply connected to the at least one air tank reservoir.

12. The assembly of claim 9, further comprising a portable compressor adapted to refill the at least one air tank reservoir.

13. A trailer spotter and transport assembly for coupling with a move and a trailer, such that when the trailer is and mover are attached to the assembly, the assembly enables the mover to reposition the trailer, the assembly comprising:
a first end comprising an axle, the axle comprising two or more wheels;
a second end comprising a mover attachment mechanism for attaching to the mover;
a center portion bearing a trailer attachment mechanism located between the first and second ends for attaching to the trailer, the first end, the second end and the center portion defining an angled drop style frame; and
wherein the trailer attachment mechanism has a first side and second side such the first side comprises a fifth wheel coupler and the second side comprises a gooseneck ball coupler.

14. The system of claim 13, wherein the mover is a forklift.

15. The system of claim 13, wherein the mover is one of a group including a towing machine, a skid steer, a telehandler, or a compact trailer.

16. The assembly of claim 1, further comprising at least one air tank reservoir comprised to release a parking brake on a trailer.

17. The assembly of claim 16, further comprising an air supply connected to the at least one air tank reservoir.

18. The assembly of claim 16, further comprising a portable compressor adapted to refill the at least one air tank reservoir.

19. The assembly of claim 13, wherein the axle supports between 10% and 90% of the weight of the trailer and the mover supports between 90% and 10% of the weight of the trailer.

20. The assembly of claim 13, wherein the axle supports between 30% and 70% of the weight of the trailer and the mover supports between 70% and 30% of the weight of the trailer.
